(19) United States
(12) Patent Application Publication
(10) Pub. No.: US 2008/0228513 A1
(43) Pub. Date: Sep. 18, 2008

(54) Software license management

(76) Inventors: Joshua A. McMillan, Clifton Park, NY (US); William Phelan, Loudonville, NY (US)

Correspondence Address: FENWICK & WEST LLP, SILICON VALLEY CENTER, 801 CALIFORNIA STREET, MOUNTAIN VIEW, CA, 94041, US

(21) Appl. No.: 11/953,855

(22) Filed: Dec. 10, 2007

Related U.S. Application Data
(60) Provisional application No. 60/869,281, filed on Dec. 8, 2006.

(51) Int. Cl. G06Q 10/00; H04L 9/32

(52) U.S. Cl. 705/1; 726/2

(57) ABSTRACT

A single easy to use system enables both developers and users to manage their applications, licenses and billing transactions. A developer portal allows a developer to manage her applications, features, code protection, packages, billing, licenses and users. A customer portal module enables a user to manage his applications, subscriptions, orders, billing information and licenses. A license activation module provides a mechanism to enforce the license of an application and offers an easy way for a user to perform license activations and license procurements. The licensing system provides a single integrated, end-to-end solution for application licensing that is application framework agnostic. The solution enables a developer to create a single protected application that they can then distribute to their users. Users are then able to use the licensing system to easily activate a license for that application, or quickly acquire a new one in a matter of minutes.

### CROSS-REFERENCE TO RELATED APPLICATIONS

This application claims the benefit of U.S. Provisional Application 60/869,281, filed on Dec. 8, 2006, which is incorporated by reference herein in its entirety

### BACKGROUND

1. Field of the Invention

The present invention is directed towards managing software rights. In particular, the present invention is directed towards methods and systems for managing software licenses.

2. Description of Background Art

Many problems face software developers and software users today. There are many things that could be made much easier for today's developer, both large and small. The time has come in the ever flattening world, to also flatten the software development life cycle (SDLC). The gap between developer and users needs to be shortened, and the playing field leveled for all involved. This can be done by providing the tools and communication methods needed to help each individual involved in the SDLC work together in an efficient and collaborative way. This will allow each individual to focus on what they do best, and create a system where success is determined by performance and satisfying the needs of users.

Due to advances in tools, technology and the global work force available to create them, software applications are becoming ever more modular and focused in their functionality and target market. Similarly, many application frameworks (a set of libraries, classes or application code that are used to implement the standard structure of an application, e.g., DotNetNuke, Microsoft .NET, etc.) take advantage of the widely available common application code and help to bring those application modules together. All of these things put together make it possible for a single individual to create powerful applications and deliver quality solutions to users.

Increased availability of tools, technology and resources does not however mean that a single individual can become a master of all trades associated with the software development life cycle. Furthermore, due to the competitive nature of this flattening world, it is becoming harder to even be considered a master in one area of the SDLC. It is difficult to constantly keep up with all the latest tools and technologies, and this leads to even more specialization, and mastery of not just a particular phase in the SDLC, but a specific discipline inside of a phase. It is becoming ever more important for an individual to focus on what they do best.

A successful software application generally does not get from idea to end user by only performing a single phase in the SDLC well. Many projects have ended in disappointment due to insufficient time, resources or money being placed in one of the phases. It is therefore necessary that while an individual focuses on doing one thing well, they also need to be able to collaborate with other individuals who do other things well. This however, can be incredibly challenging due to communication barriers such as differing cultures, languages and time zones. Even when there are two individuals working together in the same location, from the same language and culture, communication can often be an incredible barrier that prevents a project from being a success.

Even with a system that enabled the seamless communication of many people working together to create software applications to fill user needs in somewhat a global software assembly line (GSAL), there is still at least one major problem that could prevent that dream from being realized: software piracy, theft and illegal use of software applications. Key to making the GSAL work is to ensure that each individual participating receives proper compensation for their work or contribution. If this compensation is denied, an individual may not have the time to focus on doing their job as best they could. Individuals are often forced then to do more for less compensation, which often results in lower quality work.

There are many forms of software IP protection, license management and billing systems in existence today. One primary problem is that many of them are complicated and require a large amount of time to manage. Additionally, few of these systems are presented as a single, integrated solution. As explained above, the time to learn, integrate, implement and manage all of these systems is time the individuals simply do not have. Users of software applications put similar value on their time, and many systems that exist today are very cumbersome for a user, and are generally resisted as a result. There exists an opportunity to provide a system that is easy to use for both developers and users, and which will help to ensure proper compensation for developers, and help drive quality software applications for users.

### SUMMARY

The present invention provides a single, easy to use system that enables both developers and users to manage their applications, licenses and billing transactions. In one embodiment, the present invention includes a developer portal module, a license activation module and a customer portal module. The developer portal allows a developer to manage her applications, features, code protection, packages, billing, licenses and users. The customer portal module enables a user to manage his applications, subscriptions, orders, billing information and licenses. The license activation module provides a mechanism to enforce the license of an application and offers an easy way for a user to perform license activations and license procurements.

The licensing system provides a single integrated, end-to-end solution for application licensing that is application framework agnostic. The solution enables a developer to create a single protected application that they can then distribute to their users. Users are then able to use the licensing system to easily activate a license for that application, or quickly acquire a new one in a matter of minutes.

This technology enables a developer to come to a single development portal to code protect their application or application code. Regardless of which code protection or license management system an application framework enables, a developer can be assured that their application is protected, and that licenses will be enforced.

### BRIEF DESCRIPTION OF THE DRAWINGS

FIG. 1 is a block diagram of the overall architecture of an embodiment of the present invention.

FIG. 2 is a block diagram of a license activation module in accordance with an embodiment of the present invention.

FIG. 3 is a screen shot illustrating a user interface for license activation in accordance with an embodiment of the present invention.

FIG. 4 is a screen shot of a user interface providing an activation key in accordance with an embodiment of the present invention.

FIG. 5 is a screen shot of a user interface for providing an activation key in accordance with an embodiment of the present invention.

FIG. 6 illustrates a method for providing license enforcement in accordance with an embodiment of the present invention and as described above.

The figures depict preferred embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

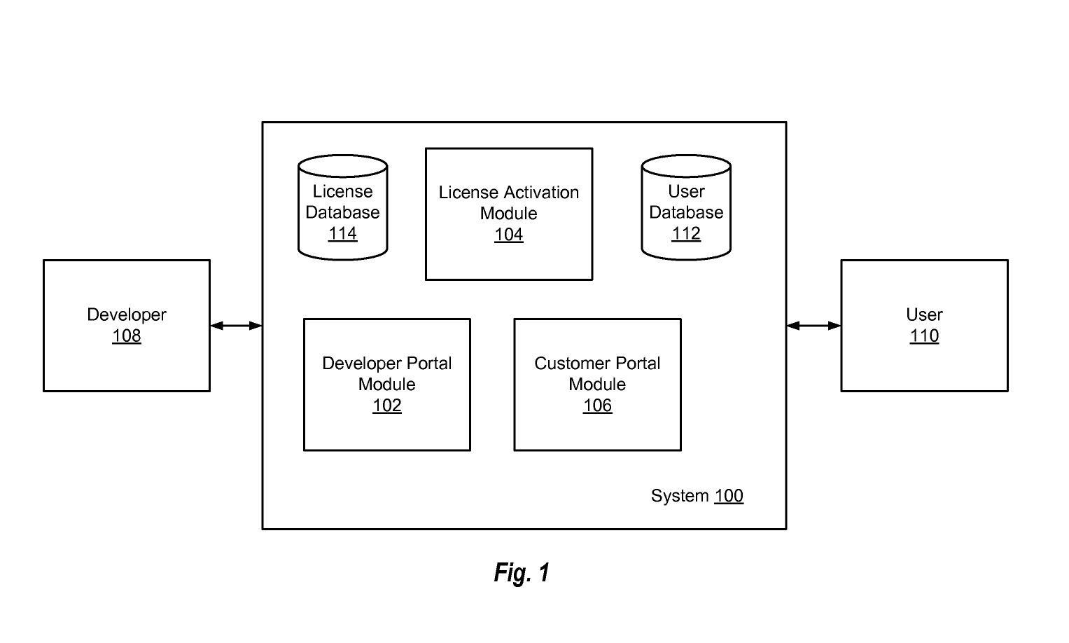

FIG. 1 illustrates a system 100 for providing software license management in accordance with an embodiment of the present invention. System 100 includes a developer mortal module 102, license activation module 104, customer portal module 106, user database 112 and license database 114. Also shown in FIG. 1 are a developer 108 and a user 110. System 100 is used by many developers and many users, but only one of each is illustrated here to preserve clarity.

Developer portal module 102 provides an interface through which developers 108 provide application and licensing information to system 100. Consumer portal module 106 is an interface through which users 110 of applications acquire application licenses. User account information is stored in user database 112. Licensing information, such as the types and cost of licenses available for various applications is stored in licensing database 114. License activation module 104 provides enforcement of licenses on behalf of developers, and procurement of licenses on behalf of users.

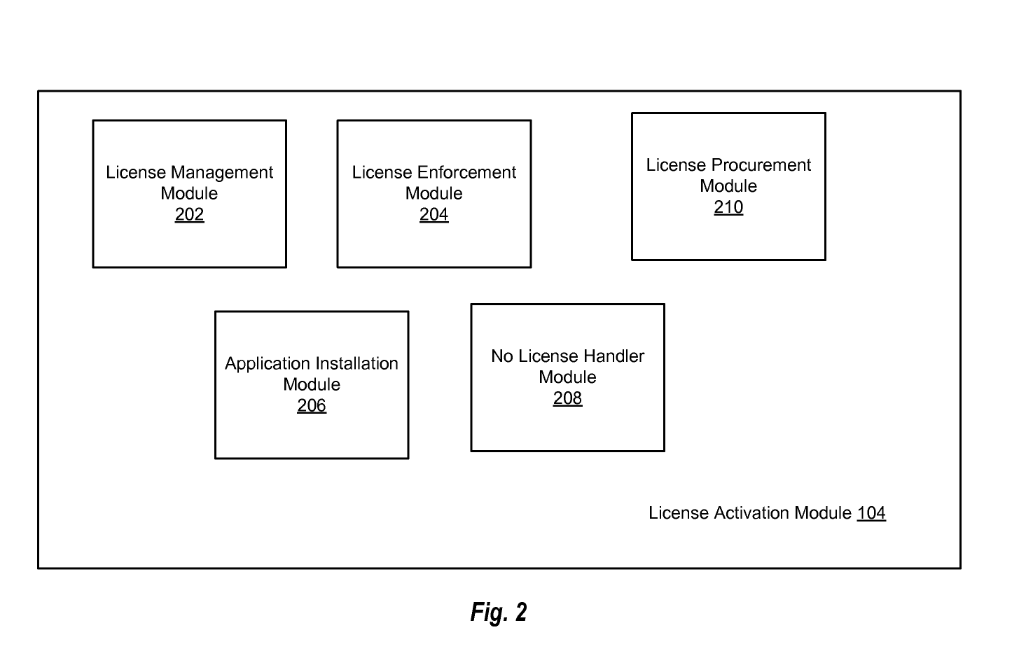

FIG. 2 provides a block diagram of license activation module 104 in accordance with an embodiment of the present invention. License activation module 104 includes a license management module 202, a license enforcement module 204, a license procurement module 210, an application installation module 206, and a no license handler module 208.

License management (LM) module 202 manages developers, applications, packages, licenses and user information. License enforcement (LE) module 204 manages the storage, validation and activation of licenses for a protected application, i.e. an application for which a license is required, in a user's environment. This is the module that forces a user to have a valid license in order to use an application. Application Installation (AI) module 206 enables users to perform point-of-install license activations. This module enables developers of select applications or application frameworks the ability to allow their users to activate a license at the time of application installation. No License Handler (NLH) module 208 enables users to perform point-of-use license activations both manually and automatically. It also allows the user the ability to acquire a new license or activation key via integration with LP module 210. License Procurement (LP) module 210 enables a user 110 to acquire a new license and activation key for a protected application. For those users that have registered with this and provided the appropriate information, this module also enables a user to perform point-of-sale license activations.

License management (LM) module 202 manages developers, applications, packages, licenses, activation keys and user information. Together with license database 114, it is the central repository that stores all licensing information. Several other modules rely on the LM module for license information, including license enforcement module 204, license procurement module 210, and application installation module 206.

LM module 202 provides a single place to store and manages licenses for developers and users; provides the ability to create and provision licenses and activation keys, and to validate them; to manage license terms; to store license subscription and usage information; and to enable other systems to leverage license information and provide functionality and interfaces around that data. LM module 202 stores information related to licenses in license database 114. This information may include, but is not limited to licenses, features, protected code, usage counts, activation keys, activations, and licensed users. When a license activation request is sent from the LE module 204 to the LM module 202, LM module 202 verifies that the license information sent to it is valid. If valid, the LM module 202 records the license activation and sends the appropriate activated license information to LE module 204.

LM module 202 provides licensing information to developers 108 and users 110 via developer portal module 102 and customer portal module 106, respectively. Many other modules communicate with LM module 202, in one embodiment through an API of LM module 202. This API enables other modules to access the information and tools contained in LM module 202. These tools enable creation of a new user in LM module 202, and provisioning of licenses for users 110.

License enforcement (LE) module 204 manages the storage, validation and activation of licenses for a protected application in a user's environment. This module is what forces a user 110 to have a valid license in order to use an application. The module communicates with LM module 202 in many cases. LE 204 module also integrates with NLH module 208 in the case that it determines there is not a valid license for the requested application or feature.

When an execution request is sent to protected application code of an application, an execution request is sent to LE module 204. LE module 204 then determines whether a valid license exists for that user 110 and that protected application code. If LE module 204 determines that a valid license does exist, LE module 204 proceeds to execute that protected application code as described below. If the application code is assigned to a feature for which usage tracking has been enabled per the application license, then the LE module also records that usage to license database 114 and user database 112.

LE module 204 may determine that a license is invalid for many reasons. For example, a license may be invalid because no license exists for the application, or for a requested feature of the application; that the license has not been activated or has expired; that billing has failed for subscription or usage based licenses; that a usage limit has been exceeded; that a total concurrent user limit has been exceeded; that the currently registered user 110 does not have valid permission or license for the application; or that the license has been deactivated. Licenses may be found invalid for additional reasons, as will be appreciated by those of skill in the art.

If LE module 204 determines that a valid license for the requested application code does not exist, in one embodiment it sends a message to user 110 or to the application to indicate that a valid license does not exist; it may also or alternatively send an execution request to NLH module 208.

When license information is sent to LE module 204 via a license activation request, LE module 204 attempts to perform a license activation for an application using that license information. This license information may be in the form of an activation key, license file, or anything else that contains license information.

If the license information that is sent to LE module 204 has already been activated and is locked to a licensed device, the license storage mechanism will be updated to reflect that additional license information, and the application will be considered licensed and activated, and LE module 204 will continue with application execution as described below.

If the license information has not yet been activated or validated, LE module 204 sends the license information to LM module 202 for validation and activation. If LM module 202 verifies that the license information is valid, LM module 202 records the license activation, and returns that activated license information to LE module 204. LE module 204 then updates the license storage mechanism to reflect this additional license information, and the application is then considered licensed and activated, and LE module 204 continues on with application execution as described below.

If LM module 202 or LE module 204 determines that the license information sent to it is not valid, it sends an error message back to user 110 or the application that initially sent the execution request to the protected application code.

If LE module 204 determines that the protected application code has a valid license, then LE module 204 translates and executes the protected code, and returns the results and response of that application code to whatever application sent the initial execution request.

License procurement (LP) module 210 enables users 110 of an application to acquire a license and corresponding activation key for a protected application. For those users that have registered with LP module 210 and provided the appropriate information, this module also enables the user 110 to perform point of sale license activations.

LP module 210 receives input parameters from other modules in order to assist with license procurement. These input parameters in one embodiment include application name, application version, developer name, package name, promotion code, feature name, current license information, user information, and SKU ID. Those of skill in the art will recognize that fewer or more parameters may be included.

LP module 210 integrates with NLH 208 and AI 206 modules to allow users 110 to quickly find available license packages for acquisition using a standardized user interface. It also provides a common, trusted billing mechanism. Using LP module 210, developers 108 can offer several flexible billing mechanisms and licensing packages. Users 110 can use LP module 210 to upgrade or downgrade licenses as needed. Application and developer feedback and rating systems can also be collected using LP module 210.

Application information may be passed into LP module 210 from another module such as LE module 204 or LM module 202. Alternatively, user 110 selects which application he wishes to acquire. To do this, the user is presented with an interface containing a list of applications for which he may acquire a license. The information contained in this list about the application may include, but is not limited to, application name, version, short description, price or price range, feedback rating, popularity rating, and certification rating. In one embodiment, a link is also provided from which to obtain more details about the application.

Information is also provided in one embodiment about the developer 108 of the application, including developer name, feedback rating, and certification rating. A link is also provided in one embodiment to obtain more detailed information about developer 108.

When an application is selected via the application selection interface, or valid application information is passed into LP module 210 from another system via an input parameter, user 110 is presented with an interface to select which package he wishes to acquire. This interface shows basic information about an application so that the user 110 can see which application he is acquiring a license for. The information shown may include, but is not limited to application name, application version, developer name, and links to additional information about the application and developer 108.

This interface presents the list of application packages that are available for acquisition by the user. The information shown in this list may include, but is not limited to package name, package description, pricing information, and licenses included in the package.

In one embodiment, if feature information was passed into this interface, e.g., by LE module 204, the interface highlights or only shows those packages with a license for that given feature.

In one embodiment, LP module 210 uses data from license database 114 and user database 112 to indicate which package the user 110 currently has, if any. The interface can also be customized in other ways to help the user to make an intelligent decision more quickly. For example, packages can be filtered based on predefined user settings or preferences, e.g., certification criteria, feedback rating, popularity rating, or developer. The user interface can also show activation keys for licenses that a user has already procured, but not yet activated. A customized view can also help to identify differences between packages based on a user's current license. Differences may include the included or excluded licenses for an application; the license terms; pricing differences; and included or excluded applications and licenses in a package or bundle. If a package contains licenses for multiple applications, the user can easily see which package makes the most sense to him based on what other licenses he already has.

In one embodiment, a user 110 can enter a previously obtained promotion code. This updates the displayed list of available packages is updated to show any promotional pricing for packages. If no such packages exist, a message will be shown to the user informing them of that fact, and the default list of packages will be shown to the user.

In one embodiment, some or all packages are restricted according to the identity of the user—that is, some users may be allowed to purchase certain licenses while others are not. LP module 210 therefore in this embodiment provides a list of only those licenses or packages available to the currently logged in user. If no such packages exist, the LP module 210 displays a message to the user informing him of that fact, and the default list of packages is shown to the user as described above.

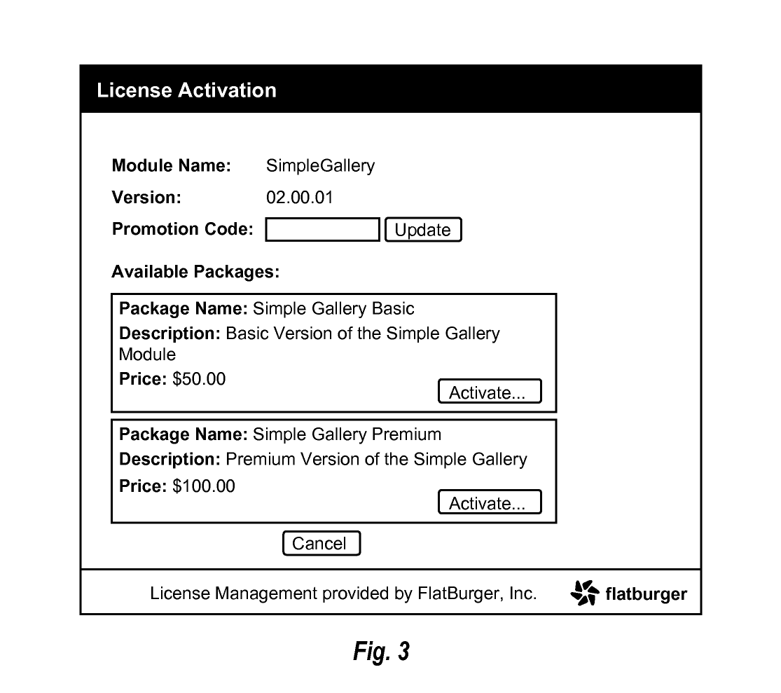

In one embodiment, the user interface includes a button or link that allows the user 108 to exit LP module 210 without selecting a package. When selected, the user will be returned to whatever interface he was at prior to entering the LP module 210. Another button or link allows the user 210 to select a new package for acquisition. When selected, the user is taken to a package selection interface such as the one illustrated in FIG. 3.

Once user 108 has selected a package, the user is authenticated by system 100, if he has not already been authenticated. Once the user has been authenticated, he is taken to an activation key delivery interface if the selected package has a price of zero, or the payment selection interface if the price is greater than zero. If the user does not already have an account with system 100, he is taken to a signup interface in order to establish an account. In one embodiment, user account data is maintained in user database 112.

If the price of a package is greater than zero, the user is prompted to select a payment method. This interface displays the basic details about the application and package that the user has selected to purchase, as well as a list of available payment methods.

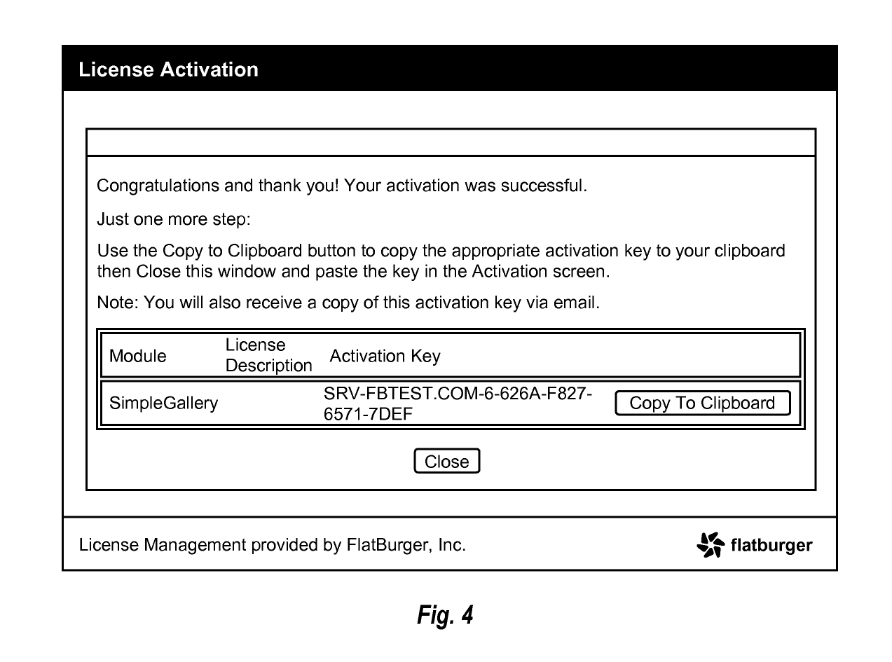

An activation key delivery interface such as the one in FIG. 4 is displayed to notify the user that he has successfully procured a new license, and display a list of all license activation keys for the procured package(s). The information contained in this list may include, but is not limited to application name, developer name, license description and activation key.

LP module 210 enables a point of sale activation in which a user purchases, obtains, procures or acquires a software application and performs a license activation at that time. Examples of ways this might be accomplished include web service calls and execution requests containing activated license information sent to the user's computer, web site or application; web service calls and execution requests sent to the user's computer, web site or application, which prompts the user's computer, web site or application to perform a license activation. This can be done by prompting the user to input his new license information, or having a module such as NLH module 208, perform an automated license activation. A license activation may also be accomplished through a custom application package that includes activated license information to be added when the application is installed.

Point of sale license activations are not always an option because of the frequent requirement that a license be locked to a licensed device. Application Installation (AI) module 206 assists users in installing and upgrading applications. AI module 206 also enables a user to perform point of install license activations, and enables developers of select applications or application frameworks the ability to allow their users to activate a license at the time of application installation.

AI module 206 enables uses to quickly and automatically perform a license activation at the point of install, as well as the quick acquisition of a license from license procurement module 210 as needed.

AI module 206 in one embodiment includes an application installation interface, although in alternative embodiments it is integrated into the installation process of an application. This may be accomplished, for example, by providing application code, controls or an API to developers. In the case of the application installation interface, an installer application can be provided for a user to use for installations and upgrades. The application prompts the user for license information or performs an automatic license activation.

Of the many applications frameworks in existence, each is at a particular stage of evolution. Few, if any, application frameworks reach the point that they can consistently implement and enforce a common code protection and licensing mechanism or framework.

One of the more common mechanisms for license management and license activation is via an application installation process of an application or application framework. Unfortunately, for this to work, it generally requires that the application framework support such a mechanism in its AI system, and even if it does, requires that each application being installed on the application framework use the likely limited set of code protection or licensing technologies supported by that application framework. Even in a mature application framework such as the Microsoft Windows operating system or the Microsoft .NET framework, developers of application code are unlikely to ever adhere to a single, or small set of, code protection and licensing technologies. The very fact that an application framework has evolved to the point that a code protection or license management system is a priority often means that several such technologies have already been commonly accepted and implemented, and that the community of application developers using that application framework is beyond the point of being able to require the use of a single system or select group of systems. This is compounded by the fact that once a license management system is implemented in an application or application code, it is generally difficult to replace due to current customers, users and licenses associated with that application using the old license management system.

It is often hard to require and enforce a single common code protection or licensing mechanism in even the most mature of application frameworks. System 100 makes irrelevant whether or not an application framework supports a common code protection or license management system. It also makes it unnecessary for an application developer to be limited to accepting only the supported code protection and license management systems of a given application framework, which are likely to be few, if any, in even the most mature application frameworks.

No license handler (NLH) module 208 enables users 110 to perform point-of-use license activations both manually and automatically. It also allows the user the ability to acquire a new license or activation key via integration with LP module 210.

When LE module 204 determines that a user 108 does not have a valid license for the application, the user may be taken to NLH module 208 to provide license information and/or an activation key. In this case, LE module 204 sends information to NLH module 208 to indicate the information about the application that is not licensed. This information in one embodiment includes the application name, version and developer name.

NLH module 208 allows a user to quickly and easily activate a license, and then continue using that application. If the user does not have a valid license for an application, the user will be able to quickly use the LP module 210 to obtain a license for that application.

NLH module 208 provides point-of-use activation and procurement capabilities to a user through a friendly interface when LE module 204 determines that there is a non-existent or invalid license for the application or feature the user 110 is trying to access. NLH module 208 also provides a way to alter the response of an Internet application if LE module 204 determines there is a deficient or non-existent license for an Internet application the user is trying to access. A user 110 does not have to navigate to a separate user interface or otherwise manually perform a license activation. Instead, the user 110 is taken directly to an interface that shows him the available packages for that specific application, and with only a few clicks, the user can have a valid activation key or information on how to activate the license. This allows developers 108 to segment applications into multiple feature levels, and up-sell those features at point of use, since the user can so easily upgrade, downgrade, or change licenses for an application.

As described earlier, when a request for a protected application is made, LE module 204 checks to see if the protected application has a valid license activated for it. If not, an execution request is sent to NLH module 208. In one embodiment, LE module 204 sends information to NLH module 208 to identify the protected application. This information in one embodiment includes the application name and version, the developer name, the feature that is not licensed, and a reason for the license failure. More or less data may also be included.

NLH module 208 checks to see if it can obtain license or license activation information automatically. If so, it activates the available license automatically, or prompts the user to select a license to activate.

If no valid license information is found, the user is prompted with the license activation interface, informing him that the application or feature they attempted to access requires a proper license, which he does not yet have, or has not yet activated. If available, the interface displays additional information to inform the user why access to the requested application or feature has failed.

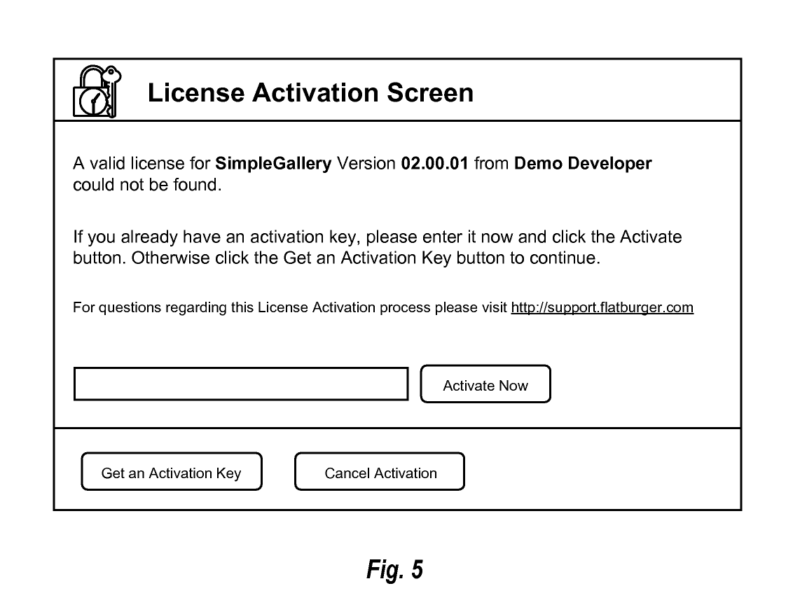

The license activation interface includes an input field allowing the user to enter an activation key, which is then passed to LE module 204. Alternatively, the user can upload a license file, or can link to LP module 204 to purchase a license or activation key. FIG. 5 illustrates a license activation screen in accordance with one embodiment of the present invention.

Once the user enters and submits an activation key or license file to LE module 204, the LE module will validate the information, activate the license, and send the validation to NLH module 208, which in turn informs the user that the activation was successful.

The interface presented to the user may be different depending on the user 110 that is attempting to use the application. For instance, if an anonymous or general end-user of the application is the one to access the application, he may be presented with a general message indicating that the application does not have a valid license or otherwise unavailable. However, if a user is an application administrator, then he will be prompted to acquire a license as described above.

NLH module 208 attempts to find a license to activate automatically, as noted above. NLH module 208 searches a number of locations for pre-existing license information or activation keys for the application. These locations may be specific to a particular application or application framework. In various embodiments, locations may include a user or application database, a web service, a pre-specified license file, a registry, and the like.

If NLH module 208 locates license information, it sends the information to LE module 204 for validation. The LE module 204 in one embodiment validates the license information with license management module 202. If LE module 204 determines that the license information is valid and has not yet been used, it either performs the license activation using that license information, or sends a response back to NLH module 208 that it should prompt the user to either approve the license activation using the license information, or select which license information to use if multiple available licenses are found for the application. Upon acceptance or selection of a license, NLH module 208 sends the license activation request to LE module 204 based on the license information selected.

NLH module 208 and LM module 202 in one embodiment can activate a license by recognizing licensing information that was not created by system 100. For instance, if a prior version of an application was previously installed and licensed by a licensing system other than system 100, NLH module 208 in one embodiment can use that license information to verify the user has permission to use the application, and activate a license for the user. NLH module 208 in one embodiment is able to detect prior licensing information algorithmically, or alternatively to interact with other licensing systems, databases or web services external to system 100 to validate the unknown license. In one embodiment, developers can provide license information to system 100, which NLH module 208 can then detect.

In one embodiment, NLH module 208 enables the use of a master license. A master license is a license that enables use and/or license activation for one or more applications or licenses. Master licenses provide an easy way to consolidate licenses for multiple applications, such as with, for example, packages, bundles multiple applications forming part of an application framework, etc.

NLH module 208 in one embodiment is implemented as application code that is included with an application, or already present in the environment that an application is installed to. NLH module 208 may alternatively have been previously installed by the user, or by another protected application or application framework.

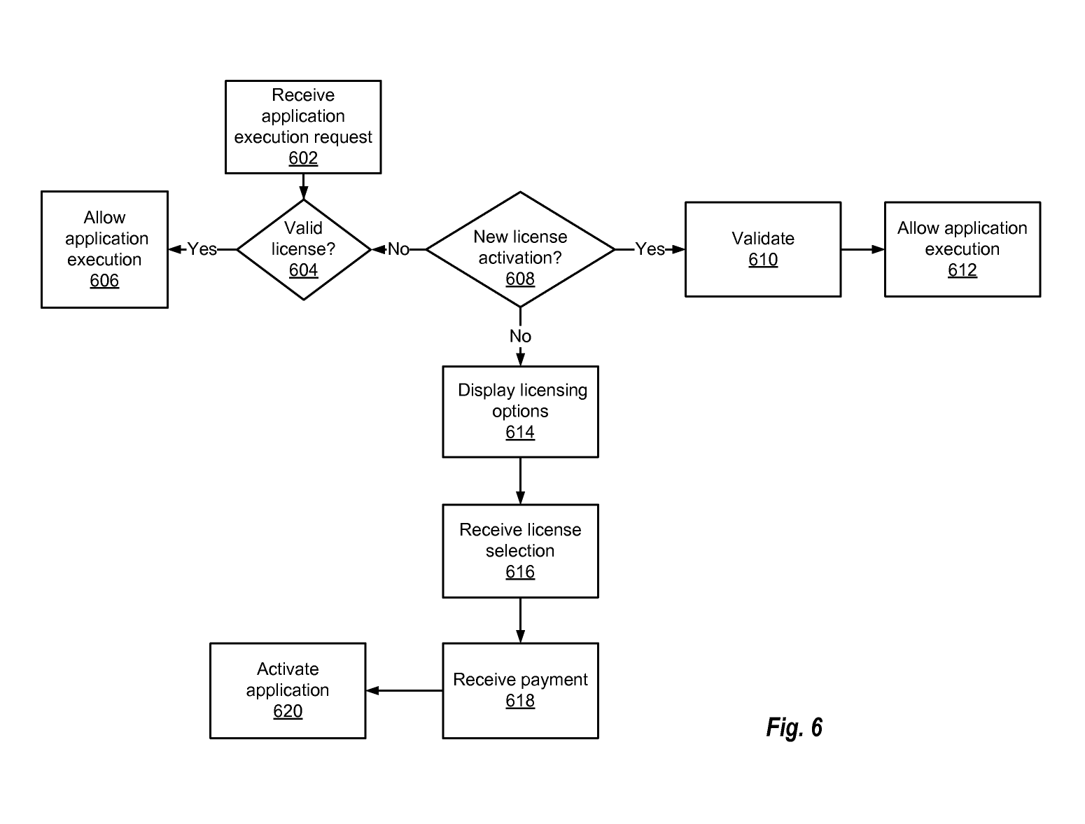

FIG. 6 illustrates a method for providing license enforcement in accordance with an embodiment of the present invention and as described above. LE module 204 receives 602 an execution request to execute a protected application. LE module 204 determines 604 whether a valid license exists for the user 110 with respect to the application code. If a valid license exists, the application is allowed 606 to execute. If a valid license is not already in place, NLH module 208 attempts to determine 608 whether a license has been acquired but is in need of activation. In one embodiment, NLH module 208 determines this automatically, while in an alternative embodiment user 110 provides information about the license. Once the license has been validated 610, the application is allowed 612 to execute.

If 608 the user 110 has not previously procured a license, NLH module 208 passes data about the user and the application to LP module 210 to enable license procurement. LP module 210 in combination with LM module 202 displays 614 available licensing options to user 110. User 110 then selects 616 a license or package to procure, and provides 618 payment for the procurement. NLH module 208 then allows 620 the application to be activated and to execute 606.

The present invention has been described in particular detail with respect to a limited number of embodiments. Those of skill in the art will appreciate that the invention may additionally be practiced in other embodiments. First, the particular naming of the components, capitalization of terms, the attributes, data structures, or any other programming or structural aspect is not mandatory or significant, and the mechanisms that implement the invention or its features may have different names, formats, or protocols. Further, the system may be implemented via a combination of hardware and software, as described, or entirely in hardware elements. Also, the particular division of functionality between the various system components described herein is merely exemplary, and not mandatory; functions performed by a single system component may instead be performed by multiple components, and functions performed by multiple components may instead performed by a single component. For example, the particular functions of the map data provider, map image provider and so forth may be provided in many or one module.

Some portions of the above description present the feature of the present invention in terms of algorithms and symbolic representations of operations on information. These algorithmic descriptions and representations are the means used by those skilled in the art to most effectively convey the substance of their work to others skilled in the art. These operations, while described functionally or logically, are understood to be implemented by computer programs. Furthermore, it has also proven convenient at times, to refer to these arrangements of operations as modules or code devices, without loss of generality.

It should be borne in mind, however, that all of these and similar terms are to be associated with the appropriate physical quantities and are merely convenient labels applied to these quantities. Unless specifically stated otherwise as apparent from the present discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system memories or registers or other such information storage, transmission or display devices.

Certain aspects of the present invention include process steps and instructions described herein in the form of an algorithm. It should be noted that the process steps and instructions of the present invention could be embodied in software, firmware or hardware, and when embodied in software, could be downloaded to reside on and be operated from different platforms used by real time network operating systems.

The present invention also relates to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Furthermore, the computers referred to in the specification may include a single processor or may be architectures employing multiple processor designs for increased computing capability.

The algorithms and displays presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will appear from the description above. In addition, the present invention is not described with reference to any particular programming language. It is appreciated that a variety of programming languages may be used to implement the teachings of the present invention as described herein, and any references to specific languages are provided for disclosure of enablement and best mode of the present invention.

Finally, it should be noted that the language used in the specification has been principally selected for readability and instructional purposes, and may not have been selected to delineate or circumscribe the inventive subject matter. Accordingly, the disclosure of the present invention is intended to be illustrative, but not limiting, of the scope of the invention.

We claim:

1. A method for providing software license management, comprising:
receiving a request from a requester to execute a software application;
determining whether a valid license associated with the requestor for executing the software application exists;
responsive to a determination that a valid license does not exist:
providing a plurality of licensing options to the requester;
receiving from the requester a selection of one of the plurality of licensing options; and
allowing the software application to be executed.

2. The method of claim 1 further comprising providing a cost associated with each of the plurality of licensing options.

3. The method of claim 2 further comprising receiving the cost associated with the selected licensing option.

4. A system for providing software license management, comprising:
a license enforcement module, adapted to receive a request from a requestor to execute a software application and to determine whether a valid license associated with the requestor for executing the software application exists; and
a no license handler module, coupled to the license enforcement module, adapted to provide, responsive to a determination that a valid license does not exist, a plurality of licensing options to the requester, and to receive from the requestor a selection of one of the plurality of licensing options.

5. The system of claim 4 wherein the license enforcement module is further adapted to receive an indication from the no license handler that one of the plurality of licensing options has been selected and to allow the application to be executed.
